(19) United States
(12) Patent Application Publication
(10) Pub. No.: US 2008/0161179 A1
(43) Pub. Date: Jul. 3, 2008

(54) NON-POROUS, NON-CORROSIVE, IMPACT-RESISTANT CERAMIC COMPOSITION

(75) Inventor: Kathleen N. Baker, Colorado Springs, CO (US)

Correspondence Address: BRENDA L. SPEER;BRENDA L SPEER, LLC, 2 NORTH CASCADE AVENUE, SUITE 1100, COLORADO SPRINGS, CO, 80903, US

(73) Assignee: CERAMIC CONTAINMENT LLC, Fountain, CO (US)

(21) Appl. No.: 12/050,852

(22) Filed: Mar. 18, 2008

Related U.S. Application Data
(63) Continuation-in-part of application No. 11/209,087, filed on Aug. 23, 2005, now abandoned.

(51) Int. Cl. C04B 33/00

(52) U.S. Cl. 501/144

(57) ABSTRACT

A non-porous, non-corrosive, impact-resistant ceramic composition; a method of making the ceramic composition; a method of making a ceramic article from the ceramic composition; and a ceramic article made from the ceramic composition are disclosed; wherein the ceramic composition preferably comprises 40.68 percent by volume of water; 0.57 percent by volume of glucose syrup; 4.52 percent by volume of oak sawdust; 0.57 percent by volume of soda ash; 0.57 percent by volume of sodium silicate; 1.69 percent by volume of corundum; 20.34 percent by volume of Alberta; 20.34 percent by volume of Tennessee ball clay; 4.52 percent by volume of kaolinite; 2.26 percent by volume of feldspar; 2.26 percent by volume of borax; and 1.69 percent by volume of kyanite.

### CROSS-REFERENCE TO RELATED APPLICATION(S)

This nonprovisional utility patent application is a continuation-in-part of prior nonprovisional utility patent application Ser. No. 11/209,087 filed Aug. 23, 2005, now abandoned.

### BACKGROUND OF THE INVENTION

1. Field of the Invention

The invention generally relates to a ceramic composition, a method of making the ceramic composition and an article made from the ceramic composition. The ceramic composition of the present invention is impervious to liquids, non-corrosive by acids or bases, and extremely resistant to breakage.

2. Description of Related Art Including Information Disclosed Under 37 CFR 1.97 and 37 CFR 1.98

Ceramic articles are very useful and take many forms, such as tiles and vessels or containers, and are easy and economical to produce. However, the practical application and use of a ceramic article is limited by its strength, durability and pH resistance. Prior art ceramic articles are typically brittle and easily broken upon impact, and subject to abrasion, erosion and corrosion by substances with which they come into contact.

In contrast to the prior art ceramic compositions and ceramic articles made therefrom, the ceramic composition of the present invention is non-porous, non-corrosive and impact-resistant. Additionally, the ceramic composition of the present invention is extremely resistant to abrasion, because the ceramic composition has a hardness rating of nine (9) on the Mohs scale of mineral hardness.

The prior art discloses various ceramic compositions that have been developed for specific purposes. For instance, U.S. Pat. No. 5,114,892 issued May 19, 1992, by Clem for a Clay Mixture Having Contamination Resistance discloses a mixture of swellable clay, such as bentonite, that is charged with an additive which provides an excess of single-charged cations which tend to neutralize the deleterious effects of double-charged cations which are naturally present in seawater and industrial waste. In contrast to the ceramic composition of the present invention, Clem teaches a clay composition suitable for application as a pond liner or a foundation sealant and which serves as a barrier to fluid penetration, rather than a clay composition which can be crafted into a ceramic article or container which is not only impervious to fluid, but also highly resistant to corrosion, abrasion and breakage.

U.S. Pat. No. 7,037,868 B2 issued May 2, 2006, by Herrero et al. for Transparent Tile Glaze discloses a zinc-free glass frit that can be used to formulate glaze compositions that develop glossy surfaces when fired on ceramic products. The disclosed zinc-free glass frit contains binders and other additives that are used to increase the mechanical strength of and to provide a protective glaze surface to the raw (“unfired”) ceramic bodies. In contrast to the ceramic composition of the present invention, Herrero et al. teach the use of a glaze to impart hardening characteristics to a ceramic article, rather than incorporating the hardening characteristics into the ceramic composition itself.

U.S. Pat. No. 7,138,084 B2 issued Nov. 21, 2006, by Bell et al. for Refractory Articles and the related continuation-in-part US Patent Application Publication 2007/0090047 A1 published Apr. 26, 2007, by Bell et al. for Refractory Articles disclose a filter for molten metal which is an open-pored porous material comprising particles of refractory material embedded in and bonded together by a carbon matrix bonding material. The disclosed refractory article can withstand elevated temperatures and is suitable for contact with molten metals. In contrast to the ceramic composition of the present invention, Bell et al. teach a ceramic composition which is able to withstand erosion from exposure to extreme elevated temperatures, rather than a ceramic composition which is able to withstand erosion from exposure to extreme elevated temperatures and corrosion from corrosive substances.

U.S. Pat. No. 7,153,338 B2 issued Dec. 26, 2006, by Bangaru et al. for Advance Erosion Resistant Oxide Cermets discloses a cermet composition (ceramic-metal composite) comprising a metal oxide that is suitable for high temperature applications wherein materials with superior erosion and corrosion resistance are required. In contrast to the ceramic composition of the present invention, Bangaru et al. teach a ceramic-metal composition which is able to withstand erosion and corrosion under high temperature conditions, rather than a non-metal containing ceramic composition which is able to withstand erosion from exposure to extreme elevated temperatures and corrosion from corrosive substances.

US Patent Application Publication 2005/0146066 A1 published Jul. 7, 2005, by Koide et al. for Porous Ceramic and Method for Production Thereof discloses a method for producing a porous ceramic which comprises a slurry preparing step of preparing a slurry containing a powdery aggregate and a hydrated crystalline material (a sugar or amino acid) having a burn-out feature, a solid matter forming step of decreasing a liquid component from the slurry prepared in the slurry preparing step, thereby forming a solid matter, and a firing step of firing the solid matter formed in the solid matter forming step to burn up the hydrated crystalline material, thereby forming a porous ceramic. In contrast to the ceramic composition of the present invention, Koide et al. teach the use of hydrated crystalline material, or sugar, which is burned out of a composition to create a porous ceramic composition, rather than to impregnate a composition with a sugar to impart hardness characteristics to a ceramic composition.

### BRIEF SUMMARY OF THE INVENTION

The ceramic composition of the present invention is non-porous, non-corrosive and impact-resistant and provides an extremely strong, durable, non-porous ceramic article that is not subject to corrosion by acids (a substance having a pH of less than 7 on the litmus scale) and bases (a substance having a pH greater than 7). Additionally, the ceramic composition of the present invention is extremely resistant to abrasion and fracture, because the ceramic composition has a hardness rating of nine (9) on the Mohs scale of mineral hardness. Testing of the ceramic composition of the present invention has substantiated that the composition has a life of at least 100 years. Based upon this testing, it is further speculated that the life of the composition may be as much as 1,000 or more years. Due to these various qualities, the ceramic composition of the present invention creates ceramic articles that lend themselves to numerous, broad applications. An illustrative, but non-limiting, example of such an application is a ceramic article which is cost effective to produce and which provides for long-term, maintenance-free, sustainable containment of hazardous waste materials.

### DETAILED DESCRIPTION OF THE INVENTION

The ceramic composition of the present invention provides cost effective, long-term, maintenance-free, sustainable containment of hazardous wastes. The ceramic composition provides for semi-permanent containment of high acid, high alkaline, high salt, medical, biomedical and contaminated wastes, in either liquid or solid form, which then may be transported safely over land or sea. The ceramic composition of the present invention also has applications as conduits for space craft and numerous military uses. Additionally, the ceramic composition of the present invention is fire resistant, sustainable for centuries, of high mechanical strength and hardness, thermally and chemically stable and resistant to high wear.

The ingredients of the ceramic composition of the present invention are combined in a preferred, specific processing sequence with preferred, specific time and temperature parameters which produce a finished ceramic product of zero porosity and resistance to all materials on both ends of the pH spectrum. The ingredient list for the ceramic composition of the present invention includes: water (preferably, distilled water), oak sawdust, glucose syrup (preferably, light corn syrup), deflocculant (preferably a combination of equal parts soda ash and sodium silicate), corundum (preferably, medical strength corundum, because of its fine, or powder, particulate size; versus regular corundum which is gritty and has a large particulate size), kyanite, borax, feldspar, kaolinite (also known as kaolin or china additive), Tennessee ball clay and Alberta.

The introduction of a sugar(s) into a clay mixture is a key factor of the ceramic composition of the present invention. Articles made from the clay mixture used in the ceramic composition of the present invention and a sugar have different properties than articles made from the same clay mixture without a sugar. The addition of a sugar to the clay mixture imparts unique and different properties to the resulting ceramic composition. Examples of these properties include higher strength and lower porosity.

Sugar is a natural organic material that negates salts. When a sugar is mixed with water and clay, ceramic articles produced from the mixture have superior crystal strength. Furthermore, sugar creates a non-permeable membrane within the clay mixture. The non-permeable membrane restricts the transport of salts and other solutes into or out of a ceramic article made of the ceramic composition of the present invention. The non-permeable membrane also provides a large surface area where chemical reactions or diffusions can take place.

Distilled water is preferred over regular, or tap, water, because distilled water has no mineral content. The mineral content of regular water could potentially interfere with the desired properties of the ceramic composition of the present invention.

Oak sawdust is the preferred sawdust for the ceramic composition of the present invention. Through a process of experimentation, it was determined that oak sawdust, in contrast to sawdust of other woods, produced the desired properties of the ceramic composition of the present invention.

A preferred glucose syrup to be used in the ceramic composition of the present invention is corn syrup. Its major use is as a thickener and for its moisture-retaining, or humectant, properties. Corn syrup is used to soften texture, add volume and prohibit crystallization. The more general term glucose syrup is often used synonymously with corn syrup, since glucose syrup is most commonly made from corn starch. Technically though, glucose syrup is any liquid starch hydrolysate of mono-, di- and higher saccharides and can be made from starch from any source, of which wheat, rice and potatoes are the most common sources. In the ceramic composition of the present invention, the use of light corn syrup is preferred over other glucose syrups, because of its corn content. Furthermore, light corn syrup is preferred over dark corn syrup, because dark corn syrup has too much cane residue which negatively impacts the desired properties of the ceramic composition of the present invention.

Soda ash or sodium carbonate (Na₂CO₃) is a sodium salt of carbonic acid and is a preferred deflocculant for the ceramic composition of the present invention. A deflocculant is an agent for thinning suspensions or slurries. It is used to reduce viscosity or prevent flocculation (a colloid phenomenon in which the disperse phase separates into discrete, usually visible, loosely aggregated particles or soft flakes rather than in a continuous mass, as in coagulation). Most deflocculants are low-molecular weight anionic polymers that neutralize positive charges on suspended particles, particularly clays. Any suitable deflocculant may be used in the ceramic composition of the present invention.

Sodium silicate (Na₂SiO₃) helps to reduce porosity and is a fluidizing agent. The preferred sodium silicate used in the ceramic composition of the present invention is 400 grit sodium silicate. Coarser grit sizes impede flow. Sodium silicate is also a deflocculant, but it is much more efficient in combination with soda ash.

Corundum is a crystalline form of aluminum oxide (Al₂O₃) and one of the rock-forming minerals. It is naturally clear, but can have different colors when impurities are present. The hardness of pure corundum is 9.0 Mohs. Corundum creates a natural glaze that permeates the ceramic composition of the present invention and which coats the finish of a ceramic article made from the ceramic composition of the present invention. Because the ceramic composition of the present invention is permeated with a glaze, it is rendered non-porous. Furthermore, the ceramic composition is non-porous and a ceramic article made therefrom will not accept a separate glaze coat, because the glaze is not able to bond to the ceramic composition. Prior art ceramic articles typically have a glaze coat applied to them (either before firing, or after firing and then are re-fired) in order to reduce porosity.

Kyanite is an aluminum silicate mineral (Al₂SiO₅) and is used primarily in refractory and ceramic products. An interesting property of kyanite is that it undergoes an irreversible expansion when fired at high temperatures. Kyanite also creates a natural glaze that permeates the ceramic composition of the present invention and which coats the finish of a ceramic article made from the ceramic composition of the present invention. Like corundum, kyanite also renders the ceramic composition non-porous and a ceramic article made therefrom will not accept a separate glaze coat, because the glaze is not able to bond to the ceramic composition. Prior art ceramic articles typically have a glaze coat applied to them (either before firing, or after firing and then are re-fired) in order to reduce porosity.

Borax {Na₂[B₄O₅(OH)₄].8H₂O}, also known as sodium borate, or sodium tetraborate, or disodium tetraborate, and is used to balance the pH of the ceramic composition of the present invention. Borax also acts as a flux, or melting agent, and is used to prevent the ceramic composition of the present invention from becoming brittle.

Feldspar is the name of a group of rock-forming minerals. Feldspar is a common raw material in the production of ceramics. Fine feldspar is the preferred ingredient for use in the ceramic composition of the present invention. Feldspar also acts as a flux and serves as a natural glaze.

Kaolinite is a clay mineral with the chemical composition Al₂Si₂O₅(OH)₄. It is a layered silicate mineral, with one tetrahedral sheet linked through oxygen atoms to one octahedral sheet of alumina octahedra. Kaolinite is one of the most common minerals. Kaolinite has a low shrink-swell capacity and a low cation exchange capacity (1-15 meq/100 g.). Kaolinite is a primary clay and is also known as kaolin or china clay.

Tennessee ball clay is a refractory clay that is able to withstand high temperatures (in excess of 2732° F. or 1500° C.). Tennessee ball clay has a ‘memory’ and when exposed to high temperatures, it does not fuse or lose its shape.

Alberta is a synthetically made clay that is duplicated to the physical and chemical properties of Albany slip. It is also known as New York slip, Alberta clay and Albany slip. A slip adds fluidity to a clay mixture and aids in the pouring of a clay mixture, such as into a mold.

The preferred method of making the ceramic composition of the present invention comprises the following steps:

Method Step One: Formation of a liquid mixture. Distilled water is placed in a suitable container and heated to within a temperature range from about 200° F. to about 212° F. (93° C.-100° C.). Once this temperature is obtained, then the container is removed from the heat source and the ingredients of oak sawdust, glucose syrup, soda ash, sodium silicate and corundum are immediately added to the heated distilled water in the required amounts and mixed together. Preferably, the liquid mixture is mixed so that air is allowed to escape. Also preferably, the soda ash, or other deflocculant, is subjected to vacuum forces to remove any moisture from it prior to its addition to the liquid mixture. Also preferably, the sodium silicate is dried with nitrate at 3 psi to remove any moisture from it prior to its addition to the liquid mixture.

Method Step Two: Formation of a dry mixture. In a separate, suitable container, the remaining dry ingredients of kyanite, borax, feldspar, kaolinite, Tennessee ball clay and Alberta are combined in the requisite amounts and mixed together.

Method Step Three: Combination of the liquid and dry mixtures. Preferably, the liquid mixture is cooled to about 68° F. (20° C.) prior to combination of the liquid and dry mixtures. While the liquid mixture is stirred continuously, the dry mixture is added slowly to the liquid mixture and stirred for approximately 10 minutes until all ingredients are combined and a smooth consistency is obtained. The combination mixture is then covered to prevent evaporation and left to stand for 12 hours, preferably within a temperature range of from about 70° F. to about 80° F. (21° C.-26.5° C.). This standing period allows for the appropriate chemical bonding of all ingredients. The specific gravity of the final, resultant combination mixture preferably has a ratio of 16 ounces by volume to 32 ounces by weight. This ratio is preferred because a combination mixture is created that is heavier than water. This level of saturation aids in the draw off of moisture from the combination mixture by a plaster mold. The reduction of the moisture content of the combination mixture during the molding process is crucial to the prevention of cracks in a ceramic article made from the ceramic composition of the present invention.

Method Step Four: Molding and drying of the combination mixture. A clean, dry plaster, or other suitable, mold that has an ambient temperature of from about 70° F. to about 80° F. (21° C.-26.5° C.) is placed on an appropriate surface and filled with the combination mixture. Alternatively, the article is formed by any procedure that will produce the desired ceramic article. Optionally, and depending on the desired ceramic article, excess combination mixture may be poured from the mold into a recovery container after approximately 45 to 60 minutes.

In an embodiment of the method of making a ceramic article with the ceramic composition of the present invention, the combination mixture at least partially dries in the mold so that the shape of the ceramic article is set before the ceramic article is removed from the mold for firing. The at least partially dried combination mixture is now in the shape of the desired ceramic article. If not completely dried when removed from the mold, the article may continue to dry until the desired moisture content is attained. The desired moisture content may be determined using known ceramic technology techniques.

In the preferred embodiment of the method of making a ceramic article with the ceramic composition of the present invention, the combination mixture is dried according to the following process steps. The mold containing the combination mixture is stood upright on a drying rack. The mold remains on the drying rack for a total of approximately 16 hours and is dried and rotated as follows:

(a) about 1 hour in an upright position;

(b) about 1 hour in a recumbent position (on its side);

(c) about 1 hour in a recumbent position that is rotated 90° (either clockwise or counterclockwise) about the horizontal axis of the mold from its initial recumbent position in step (b);

(d) about 1 hour in a recumbent position that is rotated in the same direction as the previous rotation a further 900 about the horizontal axis of the mold from its previous recumbent position in step (c); and

(e) about 12 hours in an upright position.

Upon completion of the drying time, the green ware, or unfired ceramic article, is removed from the mold and trimmed as necessary. If not completely dried when removed from the mold, the article may be allowed to continue drying until the desired moisture content is achieved. The desired moisture content may be determined using known ceramic technology techniques. In the preferred embodiment of the method of making a ceramic article with the ceramic composition of the present invention, the green ware is further dried by placing it on a drying rack for about an additional 120 hours, or 5 days, at an ambient room temperature of from about 70° F. to about 80° F. (21° C.-26.5° C.).

Method Step Five: Firing of the green ware. The kiln used in the method of the present invention is made by L L Kilns, “Liberty-Belle” model number LB 18-3-240, voltage 240 Phase I, amps 24.0, watts 6740, maximum temperature 2350° F. (1287° C.). However, any suitable kiln or firing device may be used. The green ware is placed in the kiln on spiked stilts, preferably covering the entire surface on which the green ware is resting to minimize distortion and warping of the green ware. The kiln is closed and the green ware is fired in accordance with the following steps:

(a) First, the temperature is gradually and uniformly incrementally raised to about 100° F. (37° C.) over a period of about three hours and then held at about 100° F. for about one hour;

(b) Second, the temperature is gradually and uniformly incrementally raised to about 400° F. (204° C.) over a period of about three hours and then held at about 400° F. for about one hour;

(c) Third, the temperature is gradually and uniformly incrementally raised to about 1000° F. (537° C.) over a period of about three hours and then held at about 1000° F. for about one hour;

(d) Fourth, the temperature is gradually and uniformly incrementally raised to about 1800° F. (982° C.) over a period of about three hours and then held at about 1800° F. for about one hour;

(e) Fifth, the temperature is gradually and uniformly incrementally raised to about 2090° F. (1143° C.) over a period of about thirty minutes and then held at about 2090° F. for about one hour;

(f) Sixth, the temperature is gradually and uniformly incrementally raised to about 2100° F. (1148° C.) over a period of about thirty minutes and then held at about 2100° F. for about one hour; and

(g) Seventh, the kiln is turned off and allowed to naturally cool down to about 200° F. (93° C.) before opening the kiln and removing the finished ceramic article.

Although the method steps are presented in a specific order, the disclosed subject matter encompasses variations in the order of steps. Furthermore, additional steps may be executed before, after or between the method steps disclosed without departing from the scope of the claimed subject matter.

As an illustrative, total quantity contained in the composition, the ingredients, used in the ceramic composition of the present invention are shown in the following table (as used herein a cup is defined as 8 ounces):

| | | | QUANTITY |
|---|---|---|---|
| | PERCENTAGE | QUANTITY | IN FLUID |
| INGREDIENT | BY VOLUME | IN CUPS | OUNCES |
| Alberta | 20.34 | 9 | 72 |
| Tennessee ball clay | 20.34 | 9 | 72 |
| Kaolinite | 4.52 | 2 | 16 |
| Feldspar | 2.26 | 1 | 8 |
| Corundum | 1.69 | 0.75 | 6 |
| Sodium silicate | 0.57 | 0.25 | 2 |
| Soda ash | 0.57 | 0.25 | 2 |
| Borax | 2.26 | 1 | 8 |
| Kyanite | 1.69 | 0.75 | 6 |
| Glucose syrup | 0.57 | 0.25 | 2 |
| Water | 40.67 | 18 | 144 |
| Oak sawdust | 4.52 | 2 | 16 |

Any quantity of ingredients may be used; provided, however, that the percentage relationship of each ingredient to the whole is maintained as set forth in the table above.

The ingredients used in method step one to create a liquid mixture are combined, preferably, in the following quantities and/or ratios:

| | | | QUANTITY | QUANTITY |
|---|---|---|---|---|
| | PERCENTAGE | QUANTITY IN | IN FLUID | IN CUBIC |
| INGREDIENT | BY VOLUME | CUPS | OUNCES | CENTIMETERS |
| Water | 40.67 | 18 | 144 | 4,091.49 |
| Glucose syrup | 0.57 | 0.25 | 2 | 56.83 |
| Oak sawdust | 4.52 | 2 | 16 | 454.61 |
| Soda ash | 0.57 | 0.25 | 2 | 56.83 |
| Sodium silicate | 0.57 | 0.25 | 2 | 56.83 |
| Corundum | 1.69 | 0.75 | 6 | 170.48 |

Any quantity of ingredients may be used; provided, however, that the percentage relationship of each ingredient to the whole, or the combination mixture of method step 3, is maintained as set forth in the table above.

The ingredients used in method step two to create a dry mixture are combined in the following quantities and/or ratios:

| | | | QUANTITY | QUANTITY |
|---|---|---|---|---|
| | PERCENTAGE | QUANTITY | IN FLUID | IN CUBIC |
| INGREDIENT | BY VOLUME | IN CUPS | OUNCES | CENTIMETERS |
| Alberta | 20.34 | 9 | 72 | 2,045.74 |
| Tennessee ball clay | 20.34 | 9 | 72 | 2,045.74 |
| Kaolinite | 4.52 | 2 | 16 | 454.61 |
| Feldspar | 2.26 | 1 | 8 | 227.30 |
| Borax | 2.26 | 1 | 8 | 227.30 |
| Kyanite | 1.69 | 0.75 | 6 | 170.48 |

Any quantity of ingredients may be used; provided, however, that the percentage relationship of each ingredient to the whole, or the combination mixture of method step 3, is maintained as set forth in the table above.

The ingredients used in method steps one and two have the following combined quantities and/or ratios in relation to the ceramic composition as a whole:

| | | | QUANTITY | QUANTITY |
|---|---|---|---|---|
| | PERCENTAGE | QUANTITY | IN FLUID | IN CUBIC |
| INGREDIENT | BY VOLUME | IN CUPS | OUNCES | CENTIMETERS |
| Subtotal Quantity | 48.59 | 21.5 | 172 | 4,887.07 |
| Step 1 Ingredients | | | | |
| Subtotal Quantity | 51.41 | 22.75 | 182 | 5,171.17 |
| Step 2 Ingredients | | | | |
| TOTAL QUANTITY | 100 | 44.25 | 354 | 10,058.24 |
| All Ingredients | | | | |

The present invention has been described with reference to specific embodiments; however, modifications and variations of the present invention are possible without departing from the scope of the invention, which is defined by the claims set forth below.

The invention claimed is:

1. A ceramic composition comprising:
a. 40.68 percent by volume of water;
b. 0.57 percent by volume of glucose syrup;
c. 4.52 percent by volume of sawdust;
d. 1.14 percent by volume of a deflocculant;
e. 1.69 percent by volume of corundum;
f. 20.34 percent by volume of Alberta;
g. 20.34 percent by volume of Tennessee ball clay;
h. 4.52 percent by volume of kaolinite;
i. 2.26 percent by volume of feldspar;
j. 2.26 percent by volume of borax; and
k. 1.69 percent by volume of kyanite.

2. The ceramic composition as claimed in claim 1; further wherein the water is distilled water.

3. The ceramic composition as claimed in claim 1; further wherein the glucose syrup is corn syrup.

4. The ceramic composition as claimed in claim 1; further wherein the sawdust is oak sawdust.

5. The ceramic composition as claimed in claim 1; further wherein the deflocculant is 0.57 percent by volume of soda ash and 0.57 percent by volume of sodium silicate.

6. The ceramic composition as claimed in claim 1; further wherein the corundum is medical strength corundum.

7. The ceramic composition as claimed in claim 1; further wherein the feldspar is fine feldspar.

8. A method of making a ceramic composition comprising:
a. Combining in a first process step to form a liquid mixture the ingredients:
i. 40.68 percent by volume of water;
ii. 0.57 percent by volume of glucose syrup;
iii. 4.52 percent by volume of sawdust;
iv. 1.14 percent by volume of a deflocculant; and
v. 1.69 percent by volume of corundum;
b. Combining separately in a second process step to form a dry mixture the ingredients:
i. 20.34 percent by volume of Alberta;
ii. 20.34 percent by volume of Tennessee ball clay;
iii. 4.52 percent by volume of kaolinite;
iv. 2.26 percent by volume of feldspar;
v. 2.26 percent by volume of borax; and
vi. 1.69 percent by volume of kyanite.
c. Combining in a third process step the liquid mixture and the dry mixture to create a combination mixture.

9. The method of making a ceramic composition as claimed in claim 8; further wherein the water is distilled water.

10. The method of making a ceramic composition as claimed in claim 8; further wherein the glucose syrup is corn syrup.

11. The method of making a ceramic composition as claimed in claim 8; further wherein the sawdust is oak sawdust.

12. The method of making a ceramic composition as claimed in claim 8; further wherein the deflocculant is 0.57 percent by volume of soda ash and 0.57 percent by volume of sodium silicate.

13. The method of making a ceramic composition as claimed in claim 8; further wherein the corundum is medical strength corundum.

14. The method of making a ceramic composition as claimed in claim 8; further wherein the feldspar is fine feldspar.

15. A method of making a ceramic article from a ceramic composition comprising 40.68 percent by volume of water; 0.57 percent by volume of glucose syrup; 4.52 percent by volume of sawdust; 1.14 percent by volume of a deflocculant; 1.69 percent by volume of corundum; 20.34 percent by volume of Alberta; 20.34 percent by volume of Tennessee ball clay; 4.52 percent by volume of kaolinite; 2.26 percent by volume of feldspar; 2.26 percent by volume of borax; and 1.69 percent by volume of kyanite; wherein the method comprises:
a. molding the ceramic composition into an article; and
b. drying the article.

16. The method of making a ceramic article from a ceramic composition as claimed in claim 15; further wherein the water is distilled water.

17. The method of making a ceramic article from a ceramic composition as claimed in claim 15; further wherein the glucose syrup is corn syrup.

18. The method of making a ceramic article from a ceramic composition as claimed in claim 15; further wherein the sawdust is oak sawdust.

19. The method of making a ceramic article from a ceramic composition as claimed in claim 15; further wherein the deflocculant is 0.57 percent by volume of soda ash and 0.57 percent by volume of sodium silicate.

20. The method of making a ceramic article from a ceramic composition as claimed in claim 15; further wherein the corundum is medical strength corundum.

21. The method of making a ceramic article from a ceramic composition as claimed in claim 15; further wherein the feldspar is fine feldspar.

22. The method of making a ceramic article from a ceramic composition as claimed in claim 15; further comprising:
a. drying the article about 1 hour in an upright position;
b. further drying the article about 1 hour in a first recumbent position;
c. further drying the article about 1 hour in a second recumbent position; wherein the ceramic article is initially rotated 90° about a horizontal axis from the first recumbent position;
d. further drying the article about 1 hour in a third recumbent position; where the ceramic article is rotated in the same direction as the initial rotation a further 900 about a horizontal axis from the second recumbent position; and
e. further drying the article about 12 hours in an upright position.

23. The method of making a ceramic article from a ceramic composition as claimed in claim 15; further comprising:
a. removing the article from the mold;
b. placing the article in a kiln; and
c. firing the article; further wherein firing the article comprises the steps of:
i. first, gradually and uniformly incrementally raising a temperature in the kiln to about 100° F. over a period of about three hours and then holding the temperature at about 100° F. for about one hour;
ii. second, gradually and uniformly incrementally raising the temperature in the kiln to about 400° F. over a period of about three hours and then holding the temperature at about 400° F. for about one hour;
iii. third, gradually and uniformly incrementally raising the temperature in the kiln to about 1000° F. over a period of about three hours and then holding the temperature at about 1000° F. for about one hour;
iv. fourth, gradually and uniformly incrementally raising the temperature in the kiln to about 1800° F. over a period of about three hours and then holding the temperature at about 1800° F. for about one hour;
v. fifth, gradually and uniformly incrementally raising the temperature in the kiln to about 2090° F. over a period of about thirty minutes and then holding the temperature at about 2090° F. for about one hour;
vi. sixth, gradually and uniformly incrementally raising the temperature in the kiln to about 2100° F. over a period of about thirty minutes and then holding the temperature at about 2100° F. for about one hour; and
vii. seventh, turning off the kiln and then allowing the temperature in the kiln to cool to about 200° F.; and
d. removing the article from the kiln.

24. A ceramic article made from a ceramic composition comprising 40.68 percent by volume of water; 0.57 percent by volume of glucose syrup; 4.52 percent by volume of sawdust; 1.14 percent by volume of a deflocculant; 1.69 percent by volume of corundum; 20.34 percent by volume of Alberta; 20.34 percent by volume of Tennessee ball clay; 4.52 percent by volume of kaolinite; 2.26 percent by volume of feldspar; 2.26 percent by volume of borax; and 1.69 percent by volume of kyanite.

25. The ceramic article made from a ceramic composition as claimed in claim 24; further wherein the water is distilled water.

26. The ceramic article made from a ceramic composition as claimed in claim 24; further wherein the glucose syrup is corn syrup.

27. The ceramic article made from a ceramic composition as claimed in claim 24; further wherein the sawdust is oak sawdust.

28. The ceramic article made from a ceramic composition as claimed in claim 24; further wherein the deflocculant is 0.57 percent by volume of soda ash and 0.57 percent by volume of sodium silicate.

29. The ceramic article made from a ceramic composition as claimed in claim 24; further wherein the corundum is medical strength corundum.

30. The ceramic article made from a ceramic composition as claimed in claim 24; further wherein the feldspar is fine feldspar.
